(19) United States
(12) Patent Application Publication
(10) Pub. No.: US 2013/0030116 A1
(43) Pub. Date: Jan. 31, 2013

(54) FILM, RESIN COMPOSITION AND POLYMER

(71) Applicants: Motoki Okaniwa, Tokyo (JP); Takaaki Uno, Tokyo (JP); Takashi Okada, Tokyo (JP)

(72) Inventors: Motoki Okaniwa, Tokyo (JP); Takaaki Uno, Tokyo (JP); Takashi Okada, Tokyo (JP)

(73) Assignee: JSR Corporation, Tokyo (JP)

(21) Appl. No.: 13/640,734

(22) PCT Filed: Apr. 20, 2011
(86) PCT No.: PCT/JP2011/059694

§ 371 Date: Oct. 12, 2012

(30) Foreign Application Priority Data
Apr. 30, 2010 (JP) 2010-105442

(51) Int. Cl. C08G 65/40; C08L 61/04; B05D 3/00; C09D 161/04; C09D 171/10; C08G 8/02; C08L 71/10

(52) U.S. Cl. 524/592; 528/211; 528/125; 524/611; 427/385.5

(57) ABSTRACT

Provided is a film comprising a polymer that comprises a structural unit represented by the following formula (1), wherein at least part of the terminal structure of the polymer is at least one structure selected from the group consisting of structural units represented by the following formula (2) and structural units represented by the following formula (3).

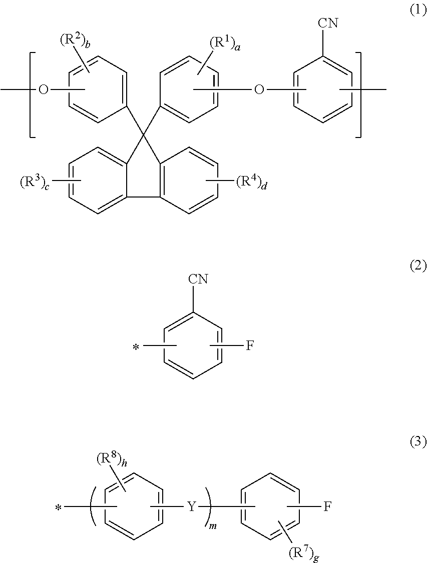

### TECHNICAL FIELD

The present invention relates to a film, a resin composition and a polymer.

### BACKGROUND ART

With recent remarkable development of information technology bringing about the trend for information devices that are lighter, thinner and smaller, transparent resins have been used as optical materials in various applications. Typical examples of the transparent resins are acrylic resins (PMMA) and polycarbonate. The PMMA and polycarbonate, though excellent in transparency, have low glass transition temperature and insufficient heat resistance, and thus are difficult to use in applications requiring high heat resistance. On the other hand, with technology advancement, the applications of engineering plastics have become wider, and polymers excellent in heat resistance, mechanical strength, transparency and the like are demanded.

As a polymer excellent in heat resistance, mechanical strength and transparency, aromatic polyethers obtained by reacting-9,9-bis(4-hydroxyphenyl)fluorene and 2,6-dihalogenated benzonitrile are proposed (Patent Literatures 1 and 2).

### CITATION LIST

### Patent Literatures

### Patent Literature 1: JP-A-2006-199746

### Patent Literature 2: JP-A-H02-45526

### SUMMARY OF INVENTION

### Technical Problem

However, films containing aromatic polyethers described in the above Patent Literatures have insufficient resistance to coloration in some cases.

The present invention has been made in view of the above problem. It is an object of the present invention to provide a film having less coloration and being excellent in heat resistance and light transmission property.

### Technical Solution

The present inventors have earnestly studied the problem, and have found that a film comprising a polymer that comprises a specific structural unit can solve the problem, thereby completing the present invention.

That is, the present invention provides the following [1] to [20].

[1] A film comprising a polymer that comprises a structural unit represented by the following formula (1), wherein at least part of the terminal structure of the polymer is at least one structure selected from the group consisting of structural units represented by the following formula (2) and structural units represented by the following formula (3).

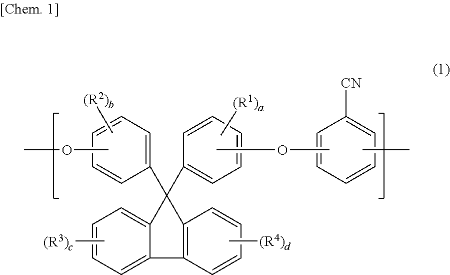

In the formula (1), R¹ to R⁴ are each independently a monovalent organic group having 1 to 12 carbon atoms; and “a” to “d” are each independently an integer of from 0 to 4.

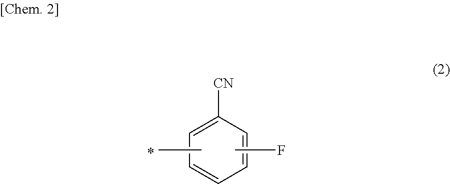

In the formula (2), the symbol “*” indicates a bond.

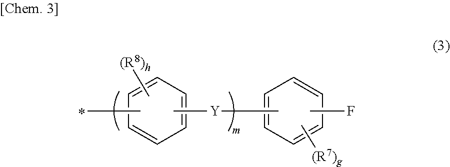

In the formula (3), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; “m” is 0 or 1; and the symbol “*” indicates a bond.

[2] The film as described in [1], wherein 75% or more of the terminal structure of the polymer is at least one structure selected from the group consisting of structural units represented by the following formula (2) and structural units represented by the following formula (3).

[3] The film as described in [1] or [2], wherein the polymer further comprises at least one structural unit selected from the group consisting of structural units represented by the following formula (4), structural units represented by the following formula (5) and structural units represented by the following formula (6).

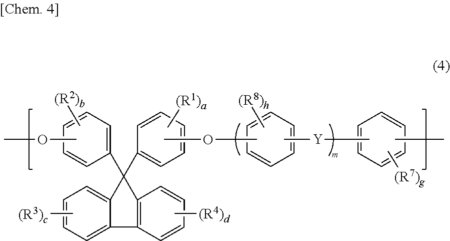

In the formula (4), R¹ to R⁴ and “a” to “d” are each independently defined in the same manner as described for R¹ to R⁴ and “a” to “d” of the formula (1); and R⁷, R⁸, Y, “m”, “g” and “h” are each independently defined in the same manner as described for R⁷, R⁸, Y, “m”, “g” and “h” of the formula (3).

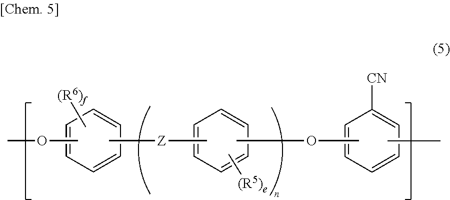

In the formula (5), R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

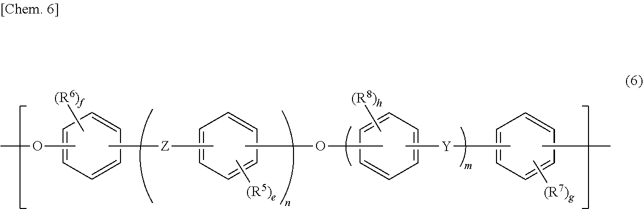

In the formula (6), R⁷, R⁸, Y, “g” and “h” are each independently defined in the same manner as described for R⁷, R⁸, Y, “m”, “g” and “h” of the formula (3); and R⁵, R⁶, Z, “n”, “e” and “f” are each independently defined in the same manner as described for R⁵, R⁶, Z, “n”, “e” and “f” of the formula (5).

[4] A film comprising a polymer obtained by reacting a component (A) with a component (B) at a molar ratio P of the component (A) to the component (B) being 1.0005<P≦1.05, wherein the component (A) comprises at least one compound selected from the group consisting of compounds represented by the following formula (7) and compounds represented by the following formula (8), and the component (B) comprises a compound represented by the following formula (B).

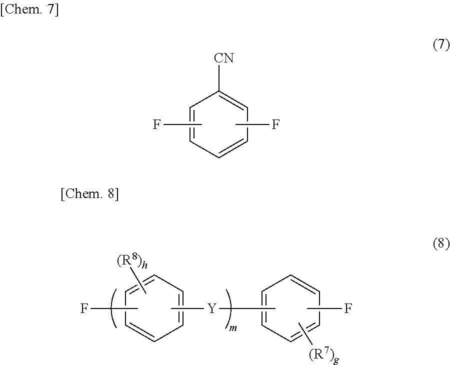

In the formula (8), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; and “m” is 0 or 1.

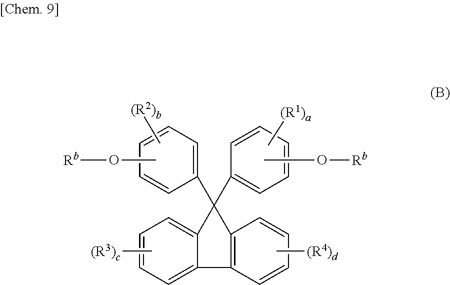

In the formula (B), R^{b} are each independently a hydrogen atom, methyl group, ethyl group, acetyl group, methanesulfonyl group or trifluoromethylsulfonyl group; R¹ to R⁴ are each independently a monovalent organic group having 1 to 12 carbon atoms; and “a” to “d” are each independently an integer of from 0 to 4.

[5] The film as described in [4], wherein the component (B) further comprises a compound represented by the following formula (B′).

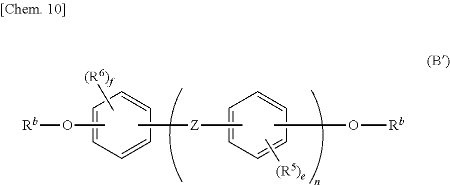

In the formula (B′), R^{b} are each independently defined in the same manner as described for R^{b} of the formula (B); R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

[6] The film as described in any one of [1] to [5], which has a glass transition temperature (Tg), as determined by dynamic viscoelasticity measurement (heating rate: 2° C./rain, frequency: Hz), of 230 to 350° C.

[7] The film as described in any one of [1] to [6], wherein the film, when having a thickness of 30 μm, has a total light transmittance in accordance with JIS K7105 transparency test method of 85% or more.

[8] The film as described in any one of [1] to [7], wherein the film, when having a thickness of 30 μm, has a YI value (yellow index) of not more than 3.0.

[9] A resin composition comprising an organic solvent and a polymer that comprises a structural unit represented by the following formula (1), wherein at least part of the terminal structure of the polymer is at least one structure selected from the group consisting of structural units represented by the following formula (2) and structural units represented by the following formula (3).

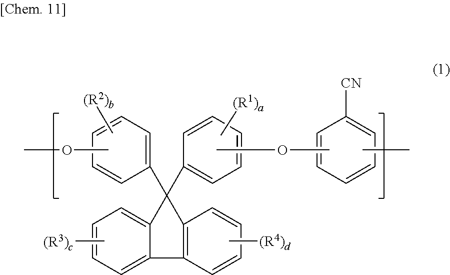

In the formula (1), R¹ to R⁴ are each independently a monovalent organic group having 1 to 12 carbon atoms; and “a” to “d” are each independently an integer of from 0 to 4.

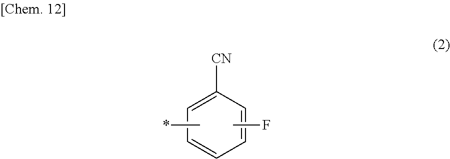

In the formula (2), the symbol “*” indicates a bond.

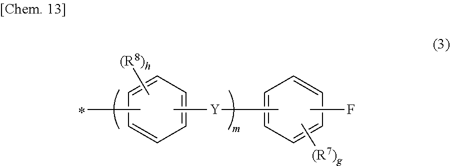

In the formula (3), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; “m” is 0 or 1; and the symbol “*” indicates a bond.

[10] The resin composition as described in [9], wherein the polymer further comprises at least one structural unit selected from the group consisting of structural units represented by the following formula (4), structural units represented by the following formula (5) and structural units represented by the following formula (6).

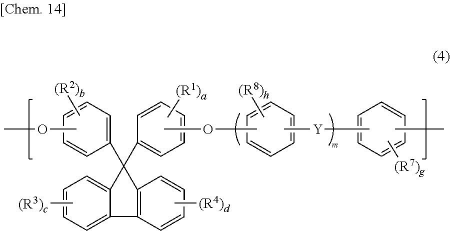

In the formula (4), R¹ to R⁴ and “a” to “d” are each independently defined in the same manner as described for R¹ to R⁴ and “a” to “d” of the formula (1); and R⁷, R⁸, Y, “m”, “g” and “h” are each independently defined in the same manner as described for R⁷, R⁸, Y, “m”, “g” and “h” of the formula (3).

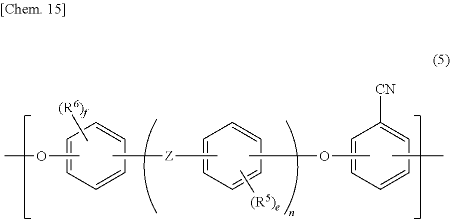

In the formula (5), R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

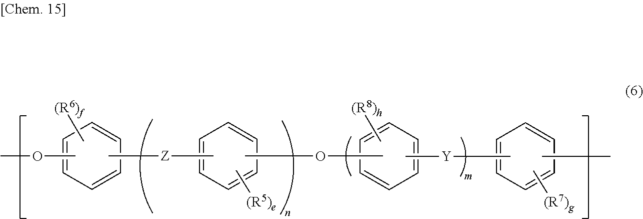

In the formula (6), R⁷, R⁸, Y, “m”, “g” and “h” are each independently defined in the same manner as described for R⁷, R⁸, Y, “m”, “g” and “h” of the formula (3); and R⁵, R⁶, Z, “n”, “e” and “f” are each independently defined in the same manner as described for R⁵, R⁶, Z, “n”, “e” and “f” of the formula (5).

[11] A resin composition comprising an organic solvent and a polymer obtained by reacting a component (A) with a component (B) at a molar ratio P of the component (A) to the component (B) being 1.0005<P≦1.05, wherein the component (A) comprises at least one compound selected from the group consisting of compounds represented by the following formula (7) and compounds represented by the following formula (8), and the component (B) comprises a compound represented by the following formula (B).

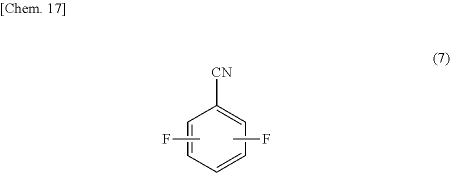

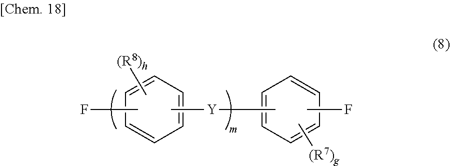

In the formula (8), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; and “m” is 0 or 1.

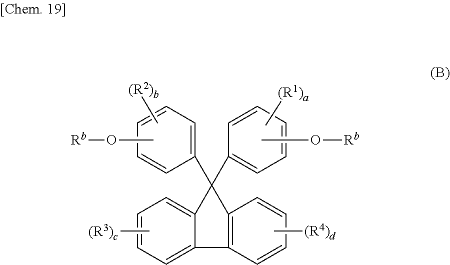

In the formula (B), R^{b} are each independently a hydrogen atom, methyl group, ethyl group, acetyl group, methanesulfonyl group or trifluoromethylsulfonyl group; R¹ to R⁴ are each independently a monovalent organic group having 1 to 12 carbon atoms; and “a” to “d” are each independently an integer of from 0 to 4.

[12] The resin composition as described in [11], wherein the component (B) further comprises a compound represented by the following formula (B′).

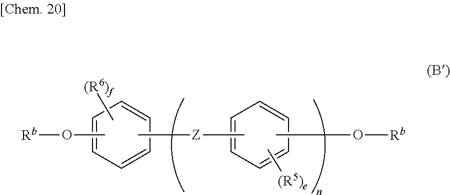

In the formula (B′), R^{b} are each independently defined in the same manner as described for R^{b} of the formula (B); R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

[13] A process for producing the film as described in any one of [1] to [8], comprising the steps of applying the resin composition as described in any one of [9] to [12] on a substrate to form a coating film, and evaporating the organic solvent from the coating film to remove the organic solvent and thereby provide a film.

[14] A polymer comprising a structural unit represented by the following formula (1), wherein at least part of the terminal structure of the polymer is at least one structure selected from the group consisting of structural units represented by the following formula (2) and structural units represented by the following formula (3).

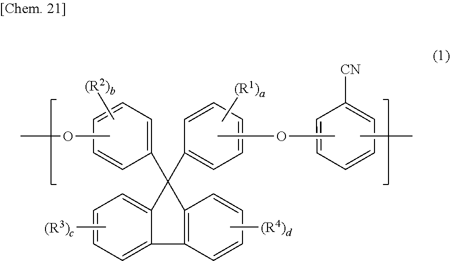

In the formula (1), R¹ to R⁴ are each independently a monovalent organic group having 1 to 12 carbon atoms; and “a” to “d” are each independently an integer of from 0 to 4.

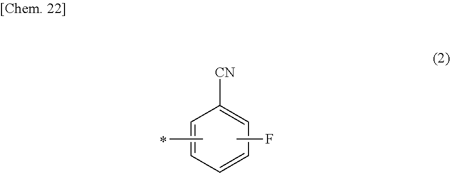

In the formula (2), the symbol “*” indicates a bond.

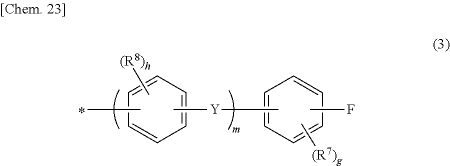

In the formula (3), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; “m” is 0 or 1; and the symbol “*” indicates a bond.

[15] The polymer as described in [14], wherein the polymer further comprises at least one structural unit selected from the group consisting of structural units represented by the following formula (4), structural units represented by the following formula (5) and structural units represented by the following formula (6).

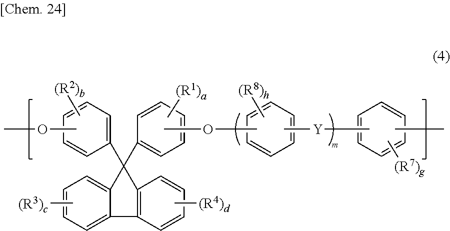

In the formula (4), R¹ to R⁴ and “a” to “d” are each independently defined in the same manner as described for R¹ to R⁴ and “a” to “d” of the formula (1); and R⁷, R⁸, Y, “m”, “g” and “h” are each independently defined in the same manner as described for R⁷, R⁸, Y, “m”, “g” and “h” of the formula (3).

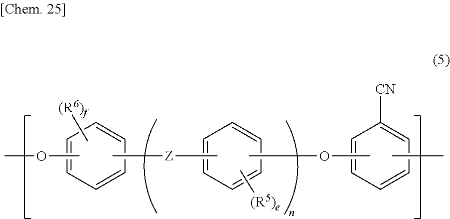

In the formula (5), R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

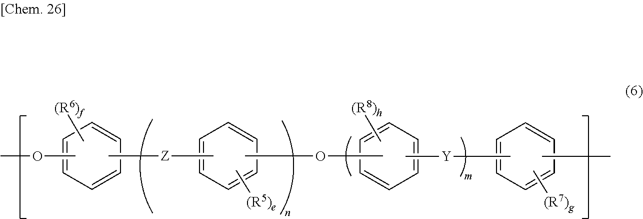

In the formula (6), R⁷, R⁸, Y, “m”, “g” and “h” are each independently defined in the same manner as described for R⁷, R⁸, Y, “m”, “g” and “h” of the formula (3); and R⁵, R⁶, Z, “n”, “e” and “f” are each independently defined in the same manner as described for R⁵, R⁶, Z, “n”, “e” and “f” of the formula (5).

[16] A polymer obtained by reacting a component (A) with a component (B) at a molar ratio P of the component (A) to the component (B) being 1.0005<P≦1.05, wherein the component (A) comprises at least one compound selected from the group consisting of compounds represented by the following formula (7) and compounds represented by the following formula (8), and the component (B) comprises a compound represented by the following formula (B).

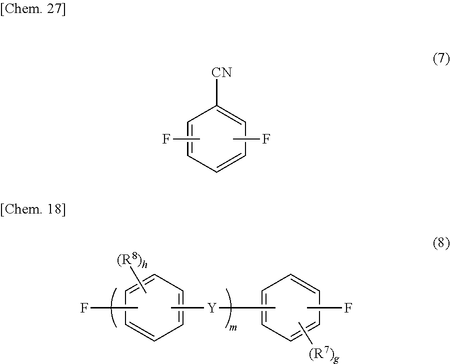

In the formula (8), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; and “m” is 0 or 1.

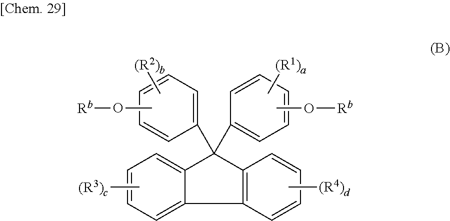

In the formula (B), R^{b} are each independently a hydrogen atom, methyl group, ethyl group, acetyl group, methanesulfonyl group or trifluoromethylsulfonyl group; R¹ to R⁴ are each independently a monovalent organic group having 1 to 12 carbon atoms; and “a” to “d” are each independently an integer of from 0 to 4.

[17] The polymer as described in [16], wherein the component (B) further comprises a compound represented by the following formula (B′).

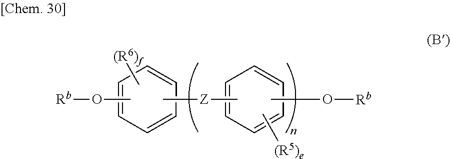

In the formula (B′), R^{b} are each independently defined in the same manner as described for R^{b} of formula (B); R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

[18] A process for synthesizing the polymer as described in any one of [14] to [17], comprising a step (I) of reacting a component (A) with a component (B) at a molar ratio P of the component (A) to the component (B) being 1.0005<P≦1.05, wherein the component (A) comprises at least one compound selected from the group consisting of compounds represented by the following formula (7) and compounds represented by the following formula (8), and component (B) comprises a compound represented by the following formula (B).

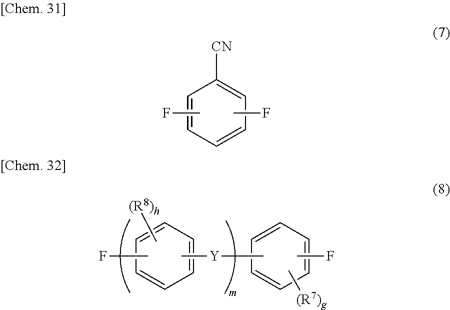

In the formula (8), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; and “m” is 0 or 1.

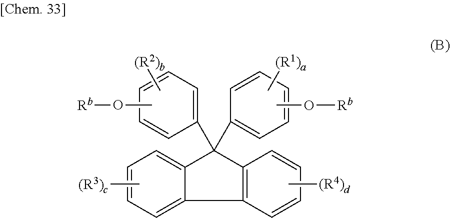

In the formula (B), R^{b} are each independently a hydrogen atom, methyl group, ethyl group, acetyl group, methanesulfonyl group or trifluoromethylsulfonyl group; R¹ to R⁴ are each independently a monovalent organic group having 1 to 12 carbon atoms; and “a” to “d” are each independently an integer of from 0 to 4.

[19] The process for synthesizing the polymer as described in [18], wherein the component (B) further comprises a compound represented by the following formula (B′).

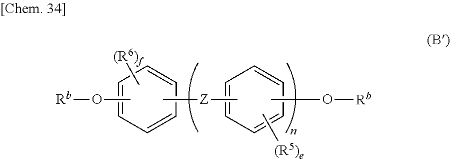

In the formula (B′), R^{b} are each independently defined in the same manner as described for R^{b} of the formula (B); R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

[20] The process for synthesizing the polymer as described in [18] or [19], which comprises a step of distilling the compound represented by the formula (7) prior to the step (I).

### Advantageous Effects of Invention

The film of the present invention has low coloration and is excellent in heat resistance and light transmission property, and therefore is employable suitably as a film for a light guide plate, a film for a polarizing plate, a film for a display, a film for an optical disk, a transparent conductive film and a film for a waveguide plate.

The resin composition of the present invention is employable suitably as a resin composition primarily used for producing the film described above.

### DESCRIPTION OF EMBODIMENTS

The film of the present invention comprises a polymer that comprises a structural unit represented by the following formula (1) (hereinafter also referred to as a “structural unit (1)”), wherein at least part of the terminal structure of the polymer is at least one structure selected from the group consisting of structural units represented by the following formula (2) and structural units represented by the following formula (3) (hereinafter also referred to as a “fluorine-containing terminal structure”).

In a desirable embodiment, preferably 75 to 100%, more preferably 85 to 100%, still more preferably 90 to 100% of the terminal structure of the polymer is the fluorine-containing terminal structure.

As used herein, the “polymer in which at least part of the terminal structure is a fluorine-containing terminal structure” refers to a polymer in which part of the number “2n” of the main chain terminals of the number “n” of compounds constituting the polymer (the compounds may differ in terms of molecular weight or structure) is a fluorine-containing terminal structure. For example, the “polymer in which 90% or more of the terminal structure is a fluorine-containing terminal structure” refers to a polymer in which 90% or more of the number “2n” of the main chain terminals of the number “n” of compounds constituting the polymer (the compounds may differ in terms of molecular weight or structure), i.e., (0.9×2n) or more of the compounds, is a fluorine-containing terminal structure. The structure of the polymer is measurable by 1H-NMR.

### <Polymer>

The film of the present invention comprises the polymer that comprises the structural unit (1) and the fluorine-containing terminal structure, and therefore is excellent in heat resistance and light transmission property and has low coloration. The film of the present invention contains the polymer in which the main chain terminals are fluorine atoms, and therefore is excellent particularly in resistance to coloration, as compared with a film containing a polymer in which the main chain terminals are other atoms such as chlorine.

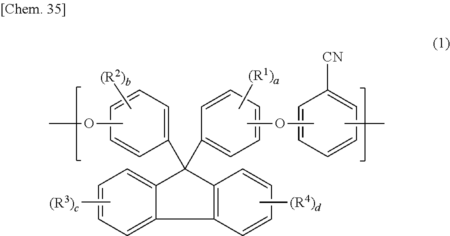

In the formula (1), R¹ to R⁴ are each independently a monovalent organic group having 1 to 12 carbon atoms; and “a” to “d” are each independently an integer of from 0 to 4, preferably 0 or 1.

Examples of the monovalent organic group having 1 to 12 carbon atoms include a monovalent hydrocarbon group having 1 to 12 carbon atoms, and a monovalent organic group having 1 to 12 carbon atoms and containing at least one kind of atom selected from the group consisting of an oxygen atom and a nitrogen atom.

Examples of the monovalent hydrocarbon group having 1 to 12 carbon atoms include a linear or branched hydrocarbon group having 1 to 12 carbon atoms, an alicyclic hydrocarbon group having 3 to 12 carbon atoms, and an aromatic hydrocarbon group having 6 to 12 carbon atoms.

As the linear or branched hydrocarbon group having 1 to 12 carbon atoms, preferred is a linear or branched hydrocarbon group having 1 to 8 carbon atoms, and more preferred is a linear or branched hydrocarbon group having 1 to 5 carbon atoms.

As the linear or branched hydrocarbon group, preferred are specifically methyl group, ethyl group, n-propyl group, isopropyl group, n-butyl group, sec-butyl group, tert-butyl group, n-pentyl group, n-hexyl group, n-heptyl group and the like.

As the alicyclic hydrocarbon group having 3 to 12 carbon atoms, preferred is an alicyclic hydrocarbon group having 3 to 8 carbon atoms, and more preferred is an alicyclic hydrocarbon group having 3 or 4 carbon atoms.

As the alicyclic hydrocarbon group having 3 to 12 carbon atoms, preferred specific examples are a cycloalkyl group such as cyclopropyl group, cyclobutyl group, cyclopentyl group and cyclohexyl group; and a cycloalkenyl group such as cyclobutenyl group, cyclopentenyl group and cyclohexenyl group. A bonding position of the alicyclic hydrocarbon group may be any carbon on the alicyclic ring.

Examples of the aromatic hydrocarbon group having 6 to 12 carbon atoms include phenyl group, biphenyl group and naphthyl group. A bonding position of the aromatic hydrocarbon group may be any carbon on the aromatic ring.

Examples of the organic group having 1 to 12 carbon atoms and containing an oxygen atom include an organic group having a hydrogen atom, a carbon atom and an oxygen atom. Among these, a preferred example is an organic group having 1 to 12 carbon atoms in total and containing a hydrocarbon group and an ether bond, a carbonyl group or an ester bond.

Examples of the organic group having 1 to 12 carbon atoms in total and containing an ether bond include an alkoxy group having 1 to 12 carbon atoms, an alkenyloxy group having 2 to 12 carbon atoms, an alkynyloxy group having 2 to 12 carbon atoms, an aryloxy group having 6 to 12 carbon atoms and an alkoxyalkyl group having 1 to 12 carbon atoms. Specific examples are methoxy group, ethoxy group, propoxy group, isopropyloxy group, butoxy group, phenoxy group, propenyloxy group, cyclohexyloxy group and methoxymethyl group.

Examples of the organic group having 1 to 12 carbon atoms in total and containing a carbonyl group include an acyl group having 2 to 12 carbon atoms, with specific examples including acetyl group, propionyl group, isopropionyl group and benzoyl group.

Examples of the organic group having 1 to 12 carbon atoms in total and containing an ester group include an acyloxy group having 2 to 12 carbon atoms, with specific examples including acetyloxy group, propionyloxy group, isopropionyloxy group and benzoyloxy group.

Examples of the organic group having 1 to 12 carbon atoms and containing a nitrogen atom include an organic group containing a hydrogen atom, a carbon atom and a nitrogen atom, with specific examples thereof including cyano group, imidazole group, triazole group, benzimidazole group and benzotriazole group.

Examples of the organic group having 1 to 12 carbon atoms and containing an oxygen atom and a nitrogen atom include an orgaic group containing a hydrogen atom, a carbon atom, an oxygen atom and a nitrogen atom, with specific examples thereof including oxazole group, oxadiazole group, benzoxazole group and benzoxadiazole group.

As the R¹ to R⁴ in the formula (1), a monovalent hydrocarbon group having 1 to 12 carbon atoms is preferred; an aromatic hydrocarbon group having 6 to 12 carbon atoms is more preferred; and phenyl group is still more preferred.

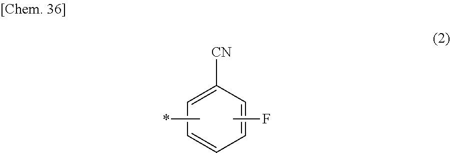

In the formula (2), the symbol “*” indicates a bond.

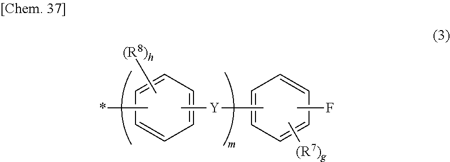

In the formula (3), Y is a single bond, —SO₂— or >C═O; R⁷ and R⁸ are each independently a halogen atom, a monovalent organic group having 1 to 12 carbon atoms or nitro group; m is 0 or 1; the symbol “*” indicates a bond; and “g” and “h” are each independently an integer of from 0 to 4, preferably 0.

As the monovalent organic group having 1 to 12 carbon atoms, organic groups as described for the monovalent organic group having 1 to 12 carbon atoms in the formula (1) and the like can be mentioned.

The polymer of the present invention may further comprise at least one structural unit selected from the group consisting of structural units represented by the following formula (4) (hereinafter also referred to as “structural units (4)”), structural units represented by the following formula (5) (hereinafter also referred to as “structural units (5)”) and structural units represented by the following formula (6) (hereinafter also referred to as “structural units (6)”). The polymer of the present invention having such a structural unit is preferred because a film comprising such a polymer has improved mechanical properties.

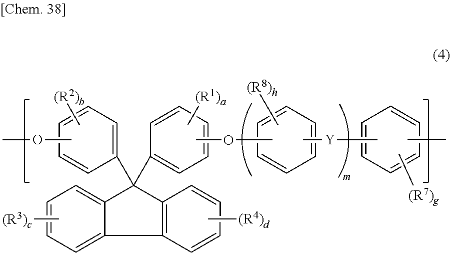

In the formula (4), R¹ to R⁴ and “a” to “d” are each independently defined in the same manner as described for R¹ to R⁴ and “a” to “d” of the formula (1); and R⁷, R⁸, Y, “m”, “g” and “h” are each independently defined in the same manner as described for R⁷ to R⁸, Y, “m”, “g” and “h” of the formula (3), provided that when “m” is 0, R⁷ is not cyano group.

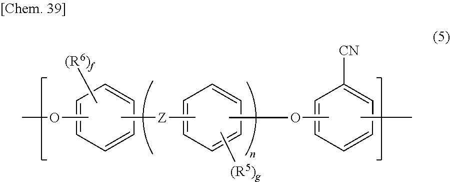

In the formula (5), R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “n” is 0 or 1; and “e” and “f” are each independently an integer of from 0 to 4, preferably 0.

As the monovalent organic group having 1 to 12 carbon atoms, organic groups as described for the monovalent organic group having 1 to 12 carbon atoms in the formula (1) and the like can be mentioned.

Examples of the divalent organic group having 1 to 12 carbon atoms include a divalent hydrocarbon group having 1 to 12 carbon atoms, a divalent halogenated hydrocarbon group having 1 to 12 carbon atoms, a divalent organic group having 1 to 12 carbon atoms and containing at least one kind of atom selected from the group consisting of an oxygen atom and a nitrogen atom, and a divalent halogenated organic group having 1 to 12 carbon atoms and containing at least one kind of atom selected from the group consisting of an oxygen atom and a nitrogen atom.

Examples of the divalent hydrocarbon group having 1 to 12 carbon atoms include a linear or branched divalent hydrocarbon group having 1 to 12 carbon atoms, a divalent alicyclic hydrocarbon group having 3 to 12 carbon atoms, and a divalent aromatic hydrocarbon group having 6 to 12 carbon atoms.

Examples of the linear or branched divalent hydrocarbon group having 1 to 12 carbon atoms include methylene group, ethylene group, trimethylene group, isopropylidene group, pentamethylene group, hexamethylene group, and heptamethylene group.

Examples of the divalent alicyclic hydrocarbon group having 3 to 12 carbon atoms include a cycloalkylene group such as cyclopropylene group, cyclobutylene group, cyclopentylene group and cyclohexylene group; and a cycloalkenylene group such as cyclobutenylene group, cyclopentenylene group and cyclohexenylene group.

Examples of the divalent aromatic hydrocarbon group having 6 to 12 carbon atoms include phenylene group, naphthylene group and biphenylene group.

Examples of the divalent halogenated hydrocarbon group having 1 to 12 carbon atoms include a linear or branched divalent halogenated hydrocarbon group having 1 to 12 carbon atoms, a divalent halogenated alicyclic hydrocarbon group having 3 to 12 carbon atoms, and a divalent halogenated aromatic hydrocarbon group having 6 to 12 carbon atoms.

Examples of the linear or branched divalent halogenated hydrocarbon group having 1 to 12 carbon atoms include difluoromethylene group, dichloromethylene group, tetrafluoroethylene group, tetrachloroethylene group, hexafluorotrimethylene group, hexachlorotrimethylene group, hexafluoroisopropylidene group and hexachloroisopropylidene group.

Examples of the divalent halogenated alicyclic hydrocarbon group having 3 to 12 carbon atoms include a group obtained by substituting at least one hydrogen atom of a group exemplified in the divalent alicyclic hydrocarbon group having 3 to 12 carbon atoms with a fluorine atom, a chlorine atom, a bromine atom or an iodine atom.

Examples of the divalent halogenated aromatic hydrocarbon group having 6 to 12 carbon atoms include a group obtained by substituting at least one hydrogen atom of a group exemplified in the divalent aromatic hydrocarbon group having 6 to 12 carbon atoms with a fluorine atom, a chlorine atom, a bromine atom or an iodine atom.

Examples of the organic group having 1 to 12 carbon atoms and containing at least one kind of atom selected from the group consisting of an oxygen atom and a nitrogen atom include a group containing a hydrogen atom, a carbon atom, an oxygen atom and/or a nitrogen atom, with examples thereof including a divalent organic group having 1 to 12 carbon atoms in total and containing a hydrocarbon group and an ether bond, a carbonyl group, an ester bond or an amide bond.

Examples of the divalent halogenated organic group having 1 to 12 carbon atoms and containing at least one kind of atom selected from the group consisting of an oxygen atom and a nitrogen atom include a group obtained by substituting at least one hydrogen atom of a group exemplified in the divalent organic group having 1 to 12 carbon atoms and containing at least one kind of atom selected from the group consisting of an oxygen atom and a nitrogen atom with a fluorine atom, a chlorine atom, a bromine atom or an iodine atom.

“Z” in the formula (5) is preferably a single bond, —O—, —SO₂—, >C═O, or a divalent organic group having 1 to 12 carbon atoms, more preferably a divalent hydrocarbon group having 1 to 12 carbon atoms, a divalent halogenated hydrocarbon group having 1 to 12 carbon atoms, or a divalent alicyclic hydrocarbon group having 3 to 12 carbon atoms.

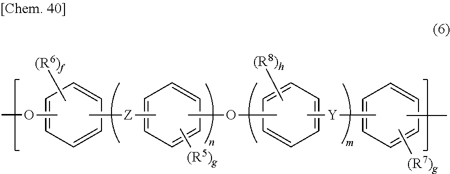

In the formula (6), R⁷, R⁸, Y, “m”, “g” and “h” are each independently defined in the same manner as described for R⁷, R⁸, Y, “m”, “g” and “h” of the formula (3); and R⁵, R⁶, Z, “n”, “e” and “f” are each independently defined in the same manner as described for R⁵, R⁶, Z, “n”, “e” and “f” of the formula (5).

In the polymer, the molar ratio of (a) the structural unit (1) to (b) the structural unit (4), the structural unit (5) and the structural unit (6) provided that the amount of the total of (a) and (b) is 100 is such that (a):(b) is preferably in the range of 50:50 to 100:0, (a):(b) is more preferably in the range of 70:30 to 100:0, (a):(b) is still more preferably in the range of 75:25 to 100:0, (a):(b) is particularly preferably in the range of 80:20 to 100:0, in terms of optical properties, heat resistance and mechanical properties.

As used herein, mechanical properties refer to nature of the polymer, such as tensile strength, elongation at break and tensile elastic modulus.

In the polymer of the present invention, the amount of the structural unit (1), the structural unit (4), the structural unit (5) and the structural unit (6) is preferably 70 mol % or more of the amount of all the structural units of the polymer, more preferably 95 mol % or more of all the structural units of the polymer.

The polymer of the present invention preferably has a weight average molecular weight (Mw) in terms of polystyrene, as measured using a HLC-8220 GPC apparatus manufactured by TOSOH (column:
TSKgelα-M, developing solvent: tetrahydrofuran (hereinafter, also referred to as “THF”), of 5,000 to 500,000, more preferably 15,000 to 400,000, still more preferably 30,000 to 300,000.

The polymer of the present invention preferably has a glass transition temperature (Tg) of 230 to 350° C., more preferably 240 to 330° C., still more preferably 250 to 300° C. The glass transition temperature (Tg) is evaluated from a peak temperature of Tan δ that is determined from the measurement performed under atmosphere at a heating rate of 2° C./min at measurement frequency of 10 Hz using a dynamic viscoelasticity analyzer, DVA-225, manufactured by ITK Co., Ltd.

The polymer of the present invention preferably has a thermal decomposition temperature as measured by thermogravimetric analysis method (TGA) of 450° C. or higher, more preferably 475° C. or higher, more preferably 490° C. or higher.

### <Polymer Synthesis Process>

The process for producing the polymer of the present invention preferably comprises, for example, a step (I) of reacting a component (A) with a component (B) at a molar ratio P of the component (A) to the component (B) being 1.0005<P≦1.05, wherein the component (A) comprises at least one compound selected from the group consisting of compounds represented by the following formula (7) (hereinafter also referred to as “compounds (7)”) and compounds represented by the following formula (8) (hereinafter also referred to as “compounds (8)”), and the component (B) comprises a compound represented by the following formula (B) (hereinafter also referred to as a “compound (B)”).

By producing the polymer by the process comprising the step (I), the polymer having the fluorine-containing terminal structure can be obtained.

In the present invention, the component (A) refers to a compound having —F that can form the structural unit (1), the structural unit (4), the structural unit (5), the structural unit (6) and the fluorine-containing terminal structure of the polymer of the present invention. The component (B) refers to a compound having —OR^{b} (wherein R^{b} is defined in the same manner as described for R^{b} of the following formula (B)) that can form the structural unit (1), the structural unit (4), the structural unit (5) and the structural unit (6) of the polymer of the present invention.

The polymer of the present invention may be a polymer synthesized by such a method.

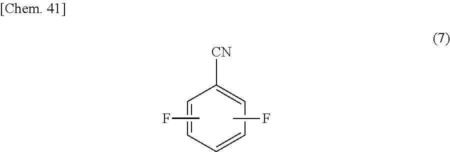

Specific examples of the compounds (7) include 2,6-difluorobenzonitrile (DFBN), 2,5-difluorobenzonitrile and 2,4-difluorobenzonitrile. In particular, in terms of reactivity, economical viewpoint, heat resistance and mechanical strength, preferred is 2,6-difluorobenzonitrile. These compounds can be used in combination of two or more kinds.

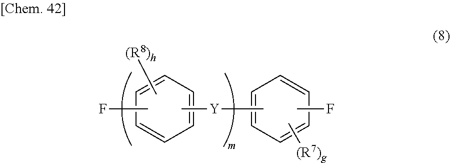

In the formula (8), R⁷, R⁸, Y, “m”, “g” and “h” are each independently defined in the same manner as described for R⁷, R⁸, Y, “m”, “g” and “h” of the formula (3).

Specific examples of the compounds represented by the formula (8) include 4,4′-difluorobenzophenone, 4,4′-difluorodiphenylsulfone, 2,4′-difluorobenzophenone, 2,4′-difluorodiphenylsulfone, 2,2′-difluorobenzophenone, 2,2′-difluorodiphenylsulfone, 3,3′-dinitro-4,4′-difluorobenzophenone and 3,3′-dinitro-4,4′-difluorodiphenylsulfone. Among these, preferred is 4,4′-difluorobenzophenone. These compounds can be used in combination of two or more kinds.

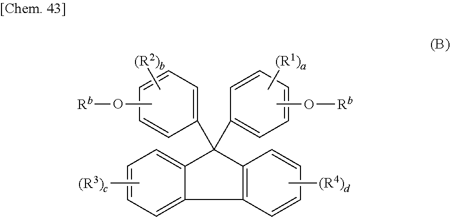

In the formula (B), R^{b} are each independently a hydrogen atom, methyl group, ethyl group, acetyl group, methanesulfonyl group or trifluoromethylsulfonyl group. Among these, a hydrogen atom is preferred. In the formula (B), R¹ to R⁴ and “a” to “d” are each independently defined in the same manner as R¹ to R⁴ and “a” to “d” of the formula (1).

As the compounds represented by the formula (B), compounds represented by the following formula (9) are preferable.

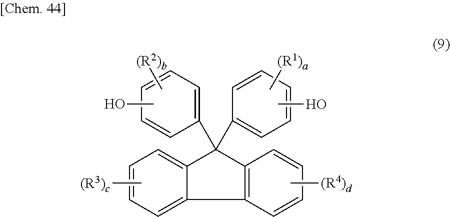

In the formula (9), R¹ to R⁴ and “a” to “d” are each independently defined in the same manner as R¹ to R⁴ and “a” to “d” of the formula (1).

Specific examples of the compounds (9) include 9,9-bis(4-hydroxyphenyl)fluorene (BPFL), 9,9-bis(3-phenyl-4-hydroxyphenyl)fluorene, 9,9-bis(3,5-diphenyl-4-hydroxyphenyl)fluorene, 9,9-bis(4-hydroxy-3-methylphenyl)fluorene, 9,9-bis(4-hydroxy-3,5-dimethylphenyl)fluorene, 9,9-bis(4-hydroxy-3-cyclohexylphenyl)fluorene, and reactive derivatives thereof. Among the above compounds, preferred are 9,9-bis(4-hydroxyphenyl)fluorene and 9,9-bis(3-phenyl-4-hydroxyphenyl)fluorene. These compounds can be used in combination of two or more kinds.

The component (B) preferably contains a compound represented by the formula (9) (hereinafter also referred to as a “compound (9)”), and as needed, preferably contains a compound represented by the following formula (B′).

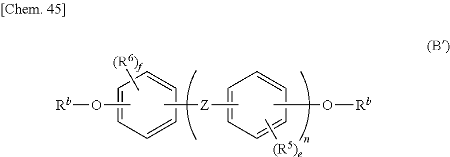

In the formula (B′), R^{b} are each independently defined in the same manner as described for R^{b} of the formula (B); and R⁵, R⁶, Z, “n”, “e” and “f” are each independently defined in the same manner as described for R⁵, R⁶, Z, “n”, “e” and “f” of the formula (5).

As the compound represented by the formula (B′), a compound represented by the following formula (10) is preferable.

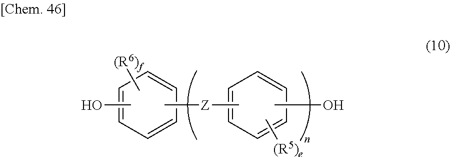

In the formula (10), R⁵, R⁶, Z, “n”, “e” and “f” are each defined in the same manner as described for R⁵, R⁶, Z, “n”, “e” and “f” of the formula (5).

Examples of the compound represented by the formula (10) include hydroquinone, resorcinol, 2-phenylhydroquinone, 4,4′-biphenol, 3,3′-biphenol, 4,4′-dihydroxydiphenylsulfone, 3,3′-dihydroxydiphenylsulfone, 4,4′-dihydroxybenzophenone, 3,3′-dihydroxybenzophenone, 1,1′-bi-2-naphthol, 1,1′-bi-4-naphthol, 2,2-bis(4-hydroxyphenyl)propane, 2,2-bis(4-hydroxyphenyl)-1,1,1,3,3,3-hexafluoropropane, and reactive derivatives thereof. Among the above compounds, preferred is 4,4′-biphenol in terms of reactivity and mechanical properties. These compounds can be used in combination of two or more kinds.

The compounds (7) are contained preferably in an amount of 80 to 100 mol %, more preferably 90 to 100 mol %, in 100 mol % of the component (A).

The compounds (9) are contained preferably in an amount of 50 to 100 mol %, more preferably 80 to 100 mol %, still more preferably 90 to 100 mol %, in 100 mol % of the component (B).

That is, the process for synthesizing the polymer of the present invention preferably comprises a step (i) of reacting the compound (7) with the compound (9).

The compound (7) is a compound that can be distilled. For this reason, it is preferred that the compound (7) is distilled prior to the step (I) or the step (i). By distilling the compound (7) prior to the step (I) or the step (i), a polymer further excellent in resistance to coloration can be obtained.

The method for distilling the compound (7) is not particularly limited. An exemplary method is a distillation under reduced pressure in the presence of an inert gas atmosphere.

The polymer of the present invention can be synthesized, more specifically, by a method described below. The component (B) (for example, the compound (B) and/or the compound (B′)) is reacted with an alkali metal compound in an organic solvent to obtain an alkali metal salt of the component (B), and then the resultant alkali metal salt is reacted with the component (A). By reacting the component (B) with the alkali metal compound in the presence of the component (A), the alkali metal salt of the component (B) may be reacted with the component (A).

Examples of the alkali metal compound used in the reaction include an alkali metal such as lithium, potassium and sodium; an alkali metal hydride such as lithium hydride, potassium hydride and sodium hydride; an alkali metal hydroxide such as lithium hydroxide, potassium hydroxide and sodium hydroxide; an alkali metal carbonate such as lithium carbonate, potassium carbonate and sodium carbonate; and an alkali metal hydrogen carbonate such as lithium hydrogen carbonate, potassium hydrogen carbonate and sodium hydrogen carbonate. These can be used in a single kind or in combination of two or more kinds.

The alkali metal compound is used in such an amount that with respect to all —O—R^{b} in the formula (B), the amount of metal atoms in the alkali metal compound is usually 1 to 3 times by equivalents, preferably 1.1 to 2 times by equivalents, more preferably 1.2 to 1.5 times by equivalents.

Examples of the organic solvent used in the reaction include N,N-dimethylacetamide (DMAc), N,N-dimethylformamide, N-methyl-2-pyrrolidone, 1,3-dimethyl-2-imidazolidinone, γ-butyllactone, sulfolane, dimethylsulfoxide, diethylsulfoxide, dimethylsulfone, diethylsulfone, diisopropylsulfone, diphenylsulfone, diphenylether, benzophenone, dialkoxybenzene (the number of carbons of the alkoxy group: 1 to 4) and trialkoxybenzene (the number of carbons of the alkoxy group: 1 to 4). Among these solvents, particularly preferred are polar organic solvents having high dielectric constant such as N-methyl-2-pyrrolidone, N,N-dimethylacetamide, sulfolane, diphenylsulfone and dimethylsulfoxide. These solvents can be used in a single kind or in combination of two or more kinds.

In the reaction, a solvent azeotropic with water, such as benzene, toluene, xylene, hexane, cyclohexane, octane, chlorobenzene, dioxane, tetrahydrofuran, anisole and phenetole is further employable.

The usage ratio of the component (A) to the component (B) is as follows. The lower limit of the molar ratio P of the component (A) to the component (B) (component (A)/component (B)) is preferably more than 1.0005, more preferably not less than 1.001, still more preferably not less than 1.003, particularly preferably not less than 1.01. The upper limit of P is preferably not more than 1.05, more preferably not more than 1.03, still more preferably not more than 1.025, particularly preferably not more than 1.02. The usage ratio of the compound (7) to the compound (9) in the step (i) is preferably within the above range.

The molar ratio of the component (A) to the component (B) being within the above range is preferred in terms of being able to provide the polymer having the fluorine-containing terminal structure, further provide the polymer in which 75 to 100% or more of the terminal structure is the fluorine-containing terminal structure, and provide the polymer having less coloration and having a molecular weight sufficient for film formation.

In reacting the component (A) with the component (B), the sum of the mass of the monomers of the component (A) and the component (B) in the reaction system is preferably 5 to 50% by mass, more preferably 10 to 40% by mass. The reaction temperature is preferably 60 to 250° C., more preferably 80 to 200° C. The reaction time is preferably 15 minutes to 100 hours, more preferably 1 hour to 24 hours.

### <Resin Composition>

The resin composition of the present invention comprises the polymer of the present invention and an organic solvent.

A mixture of the polymer obtained by the above process and the organic solvent can be used, as it is, as the resin composition for producing the film of the present invention. By using such a resin composition, the film can be produced easily and inexpensively.

Alternatively, the resin composition can be prepared by a method in which the polymer is isolated (purified) as a solid component from the mixture of the polymer obtained by the above process and the organic solvent, and the solid component is redissolved in an organic solvent. By using such a resin composition, the film can be produced which has much less coloration and has excellent light transmission property.

The isolation (purification) of the polymer as the solid component can be carried out, for example, by reprecipitating the polymer in a poor polymer solvent such as methanol, filtering the solution, and then drying a cake under reduced pressure.

Suitable examples of the organic solvent for dissolving the polymer include methylene chloride, tetrahydrofuran, cyclohexanone, N,N-dimethylformamide, N,N-dimethylacetamide, N-methylpyrrolidone and γ-butyrolactone. In terms of coatability and economical viewpoint, more preferred are methylene chloride, N,N-dimethylacetamide and N-methylpyrrolidone. These solvents can be used in a single kind or in combination of two or more kinds.

The resin composition can further comprise an anti-aging agent. By comprising the anti-aging agent, the resultant film can have much improved durability.

A preferable example of the anti-aging agent is a hindered phenol-typed compound.

Examples of the hindered phenol-typed compound employable in the present invention include triethyleneglycol-bis[3-(3-tert-butyl-5-methyl-4-hydroxypheny 1)propionate], 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-3,5-triazine, pentaerythritoltetrakis[3-(3,5-tert-butyl 4-hydroxyphenyl)propionate], 1,1,3-tris[2-methyl-4-[3-(3,5-di-tert-butyl-4-hydroxyphenyl)propionyloxy]-5-tert-butylphenyl]butane, 2,2-thio-diethylenebis[3-(3,5-di-tert-butyl-4-hydroxyphenyl)propionate], octadecyl-3-(3,5-di-tert-butyl-4-hydroxyphenyl)propionate, N,N-hexamethylenebis(3,5-di-tert-butyl-4-hydroxy-hydrocinnamamide), 1,3,5-trimethyl-2,4,6-tris(3,5-di-tert-butyl-4-hydroxybenzyl)benzene, tris-(3,5-di-tert-butyl-4-hydroxybenzyl)-isocyanurate, and 3,9-bis[2-[3-(3-tert-butyl-4-hydroxy-5-methylphenyl)propionyl oxy]-1,1-dimethylethyl]-2,4,8,10-tetraoxaspiro[5.5]undecane. These anti-aging agents can be used in a single kind or in combination of two or more kinds.

In the present invention, the anti-aging agent is used preferably in an amount of 0.01 to 10 parts by weight based on 100 parts by weight of the polymer.

The polymer concentration of the resin composition of the present invention is usually 5 to 40% by mass, preferably 7 to 25% by mass, though depending on a molecular weight of the polymer. When the polymer concentration of the composition is within the above range, the formation of a thick film is possible, and a pinhole can hardly occur and a film excellent in surface smoothness can be provided.

The viscosity of the resin composition is preferably 50 to 100,000 mPa·s, more preferably 500 to 50,000 mPa·s, still more preferably 1000 to 20,000 mPa·s, though depending on a molecular weight or a concentration of the polymer. When the viscosity of the composition is within the above range, excellent retentivity of the resin composition during the film formation is achieved, and the film thickness is easily controlled, leading to easy formation of a film.

### <Film>

The film of the present invention comprises the polymer according to the present invention. The film of the present invention may comprise, in addition to the polymer of the present invention, additives according to desired applications, but it is preferable that the film of the present invention consists essentially of the polymer of the present invention.

The process for producing the film of the present invention preferably comprises a step of applying the resin composition on a support to form a coating film, and a step of evaporating the organic solvent from the coating film to remove the organic solvent and thereby obtain a film.

Exemplary methods for applying the resin composition on a support to form a coating film include roll coating, gravure coating, spin coating, slit coating and a method using a doctor blade.

Examples of the support include a polyethylene terephthalate (PET) film and a SUS plate.

The thickness of the coating film is not particularly limited. It is, for example, 1 to 250 μm, preferably 2 to 150 μm, more preferably 5 to 125 μm.

The step of evaporating the organic solvent from the coating film to remove the organic solvent can be carried out, specifically, by heating the coating film. By heating the coating film, the organic solvent in the coating film can be evaporated and thus removed. The heating conditions can be arbitrarily determined according to a support or a polymer, as long as the organic solvent is evaporated. For example, the heating temperature is preferably from 30 to 300° C., more preferably from 40 to 250° C., still more preferably from 50 to 230° C.

The heating time is preferably 10 minutes to 5 hours. The heating may be carried out in two or more stages. A specific method is for example such that drying is carried out at a temperature of 30 to 80° C. for 10 minutes to 2 hours, and then heating is carried out at a temperature of 100 to 250° C. for 10 minutes to 2 hours. As needed, drying may be carried out under nitrogen atmosphere or under reduced pressure.

The resultant film is preferably delaminated from the support and used. Depending on the type of a support used, the resultant film can be used without being removed from the support.

The film of the present invention preferably has a glass transition temperature (Tg) of 230 to 350° C., more preferably 240 to 330° C., still more preferably 250 to 300° C. The glass transition temperature (Tg) is evaluated from a peak temperature of Tan θ that is determined from the measurement performed under atmosphere at a heating rate of 2° C./min at a measurement frequency of 10 Hz using a dynamic viscoelasticity analyzer, DVA-225, manufactured by ITK Co., Ltd. The film of the present invention, by having such a glass transition temperature, has excellent heat resistance.

The film of the present invention preferably has a thickness of 1 to 250 μm, more preferably 2 to 150 μm. When the film of the present invention is used as a substrate, the thickness is particularly preferably 10 to 125 μm.

The film of the present invention, when having a thickness of 30 μm, preferably has a total light transmittance in accordance with JIS K7105 transparency test method of 85% or more, more preferably 88% or more. The total light transmittance is measurable using a haze meter, SC-3H, manufactured by Suga Test Instruments Co., Ltd.

The film of the present invention, when having a thickness of 30 μm, preferably has a light transmittance at a wavelength of 400 nm of 70% or more, more preferably 75% or more, still more preferably 80% or more. The light transmittance at a wavelength of 400 nm is measurable using an ultra-violet and visible spectrophotometer, V-570, manufactured by JASCO Corporation.

The film of the present invention, when having a thickness of 30 μm, preferably has a YI value (yellow index) of not more than 3.0, more preferably not more than 2.5, still more preferably not more than 2.0. The YI value is measurable using a color meter, SM-T, manufactured by Suga Test Instruments Co., Ltd.

The film of the present invention, when having a thickness of 30 μm, preferably has a YI value, as measured after heating the film with a hot air drier under atmosphere at 230° C. for 1 hour, of not more than 3.0, more preferably not more than 2.5, still more preferably not more than 2.0.

The film of the present invention, when having a thickness of 30 μm, preferably has a retardation (Rth) in the thickness direction of not more than 300 nm, more preferably not more than 50 nm, still more preferably not more than 10 nm. The retardation is measurable using a RETS spectroscope manufactured by Otsuka Electronics Co., Ltd.

The film of the present invention preferably has a refractive index of 1.55 to 1.75, more preferably 1.60 to 1.70, with respect to light having a wavelength of 633 nm. The refractive index is measurable using a haze meter, SC-3H, manufactured by Suga Test Instruments Co., Ltd.

The film of the present invention preferably has a tensile strength of from 50 to 200 MPa, more preferably from 80 to 150 MPa. The tensile strength is measurable using a tensile tester 5543 manufactured by INSTRON.

The film of the present invention preferably has an elongation at break of from 10 to 100%, more preferably from 15 to 100%. The elongation at break is measurable using a tensile tester 5543 manufactured by INSTRON.

The film of the present invention preferably has a tensile elastic modulus of from 2.5 to 4.0 GPa, more preferably from 2.7 to 3.7 GPa. The tensile elastic modulus is measurable using a tensile tester 5543 manufactured by INSTRON.

The film of the present invention has low coloration and is excellent in light transmission property, and therefore is employable suitably as e.g., a film for a light guide plate, a film for a polarizing plate, a film for a display, a film for an optical disk, a transparent conductive film and a film for a waveguide plate.

The polymer and the resin composition of the present invention are employable suitably as a resin composition primarily used for forming the film described above.

### EXAMPLES

Hereinafter, the present invention is specifically described with reference to Examples. The present invention is no way limited by these Examples.

### (1) Structure Analysis

The analysis of structures of polymers obtained in the following Examples and Comparative Examples was carried out by IR (ATR method, FT-IR, 6700, manufactured by NICOLET) and by 1H-NMR (ADVANCE500, manufactured by BRUKAR).

### (2) Weight Average Molecular Weight and Number Average Molecular Weight

The weight average molecular weight and the number average molecular weight of polymers obtained in the following Examples and Comparative Examples were measured using a HLC-8220 GPC apparatus manufactured by TOSOH (column: TSKgelα-M, developing solvent: tetrahydrofuran (hereinafter, also referred to as “THF”)).

### (3) Glass Transition Temperature (Tg)

The glass transition temperature of films for evaluation obtained in the following Examples and Comparative Examples was evaluated from a peak temperature of Tan δ that was determined from the measurement performed under atmosphere at a heating rate of 2° C./rain at measurement frequency of 10 Hz using a dynamic viscoelasticity analyzer, DVA-225, manufactured by ITK Co., Ltd.

### (4) Mechanical Properties

The elongation at break at room temperature of films for evaluation obtained in the following Examples and Comparative Examples was measured in accordance with JIS K7127.

### (5) Optical Properties

The total light transmittance and YI (yellow index) of films for evaluation obtained in the following Examples and Comparative Examples were measured in accordance with JIS K7105 transparency test method. Specifically, the total light transmittance was measured using a haze meter, SC-3H, manufactured by Suga Test Instruments Co., Ltd., and the YI value was measured using a color meter, SM-T, manufactured by Suga Test Instruments Co., Ltd. (YI before heating).

Further, the YI value after heating the films for evaluation obtained in the following Examples and Comparative Examples with a hot air drier under atmosphere at 230° C. for 1 hour was measured using a color meter, SM-T, manufactured by Suga Test Instruments Co., Ltd. (YI after heating). The measurement was performed under conditions stipulated in JIS K 7105.

The retardation (Rth) of films for evaluation obtained in the following Examples and Comparative Examples was measured using a RETS spectroscope manufactured by Otsuka Electronics Co., Ltd. The evaluation of the retardation is based on the film thickness standardized at 30 μm.

The films for evaluation obtained in the following Examples and Comparative Examples were subjected to heat treatment under atmosphere at 230° C. for 1 hour, and the heat-treated films were dissolved in N,N-dimethylacetamide, to prepare a solution having a polymer concentration of 10 wt %. The YI value of the resultant solution was measured using a UV/VIS/NIR spectroscope, V-570, manufactured by JASCO Corporation (solution YI after heating).

### Example 1

A 3 L four-neck flask was charged with Component (A): 2,6-difluorobenzonitrile (DFBN) (70.59 g (0.5075 mol)), Component (B): 9,9-bis(4-hydroxyphenyl)fluorene (BPFL) (175.21 g (0.5000 mol)), potassium carbonate (82.93 g (0.6 mol)), N,N-dimethylacetamide (hereinafter also referred to as a “DMAc”) (983 g) and toluene (496 g). Then, to the four-neck flask, a thermometer, a stirrer, a three-way cock with a nitrogen introducing tube, a Dean-Stark tube and a cooling tube were attached.

After the flask was purged with nitrogen, the resultant solution was reacted at 140° C. for 3 hours. Water generated was removed as needed through the Dean-Stark tube, and when the generation of water was not recognized, temperature was gradually increased to 160° C., and at this temperature, the reaction was performed for 5 hours.

After the solution was cooled to room temperature (25° C.), a salt generated was removed using a filter paper. The filtrate was poured into methanol for reprecipitation. The solution was subjected to filtration to isolate cake (residue). The resultant cake was vacuum dried at 60° C. overnight, thereby obtaining a white powder (polymer) (amount yielded: 219 g, yield: 97%).

With regard to the resultant polymer, the analysis of a structure and a terminal group, and the measurement of a weight average molecular weight and a number average molecular weight were carried out.

The result was as follows: the characteristic absorption of infrared absorption spectrum was at 3035(C—H stretch), 2229 cm⁻¹ (CN), 1574 cm⁻¹, 1499 cm⁻¹ (aromatic ring skeleton absorption), 1240 cm⁻¹ (—O—). The resultant polymer had the structural unit (1).

By 1H-NMR, 6.60 to 6.62 ppm (para-position hydrogen with respect to the terminal group fluorine atom), 6.83 to 6.86 ppm (ortho-position hydrogen with respect to the terminal group fluorine atom) were observed. From the result of the measurement by 1H-NMR, 95% of the terminal structure of the polymer was found to be the structure represented by the formula (2).

The resultant polymer had a weight average molecular weight of 82,000 and a number average molecular weight of 20,500.

Properties of the polymer obtained are set forth in Table 1.

Subsequently, the resultant polymer was redissolved in DMAc to obtain a resin composition having a polymer concentration of 20% by mass. The resin composition was applied using a doctor blade on a support composed of a polyethylene terephthalate (PET), and was dried at 80° C. for 30 minutes and then dried at 150° C. for minutes, thereby forming a film. Then, the film was delaminated from the PET substrate. Thereafter, the film was fixed to a metal frame, and dried at 200° C. for 2 hours, thereby obtaining a film for evaluation with a thickness 30 μm. Properties of the film for evaluation are set forth in Table 1.

### Example 2

The same operation was performed as in Example 1 except that the blending amount of 2,6-difluorobenzonitrile was changed to 70.25 g (0.5050 mol). From the result of the measurement by 1H-NMR, 94% of the terminal structure of the polymer was found to be the structure represented by the formula (2). Properties of the resultant polymer and film for evaluation are set forth in Table 1.

### Example 3

The same operation was performed as in Example 1 except that the blending amount of 2,6-difluorobenzonitrile was changed to 71.29 g (0.5125 mol). From the result of the measurement by 1H-NMR, 98% of the terminal structure of the polymer was found to be the structure represented by the formula (2). Properties of the resultant polymer and film for evaluation are set forth in Table 1.

### Example 4

The same operation was performed as in Example 2 except that 9,9-bis(4-hydroxyphenyl)fluorene was replaced by 9,9-bis(3-phenyl-4-hydroxyphenyl)fluorene (251.30 g (0.5000 mol)). From the result of the measurement by 1H-NMR, 95% of the terminal structure of the polymer was found to be the structure represented by the formula (2). Properties of the resultant polymer and film for evaluation are set forth in Table 1.

### Example 5

The same operation was performed as in Example 2 except that as Component (B), 9,9-bis(4-hydroxyphenyl)fluorene (175.21 g) was replaced by 9,9-bis(4-hydroxyphenyl)fluorene (87.60 g (0.2500 mol)) and 9,9-bis(3-phenyl-4-hydroxyphenyl)fluorene (125.65 g (0.2500 mol)). From the result of the measurement by 1H-NMR, 92% of the terminal structure of the polymer was found to be the structure represented by the formula (2). Properties of the resultant polymer and film for evaluation are set forth in Table 1.

### Example 6

The same operation was performed as in Example 2 except that as Component (B), 9,9-bis(4-hydroxyphenyl)fluorene (175.21 g) was replaced by 9,9-bis(4-hydroxyphenyl)fluorene (140.16 g (0.4000 mol)) and 4,4′-biphenol (18.62 g (0.1000 mol)). From the result of the measurement by 1H-NMR, 93% of the terminal structure of the polymer was found to be the structure represented by the formula (2). Properties of the resultant polymer and film for evaluation are set forth in Table 1.

### Example 7

The same operation was performed as in Example 1 except that as Component (B), 9,9-bis(4-hydroxyphenyl)fluorene (175.21 g) was replaced by 9,9-bis(4-hydroxyphenyl)fluorene (87.60 g (0.2500 mol) and 4,4′-biphenol (46.55 g (0.2500 mol)). From the result of the measurement by 1H-NMR, 96% of the terminal structure of the polymer was found to be the structure represented by the formula (2). Properties of the resultant polymer and film for evaluation are set forth in Table 1.

### Example 8

The same operation was performed as in Example 1 except that as Component (A), 2,6-difluorobenzonitrile (70.59 g) was replaced by 2,6-difluorobenzonitrile (52.94 g (0.3806 mol)) and 4,4′-difluorobenzophenone (27.69 g (0.1269 mol)). From the result of the measurement by 1H-NMR, 91% of the terminal structure of the polymer was found to be the structure represented by the formula (2) and the structure represented by the formula (3). Properties of the resultant polymer and film for evaluation are set forth in Table 1.

By 1H-NMR, 7.13 to 7.16 ppm (ortho-position hydrogen with respect to the terminal group fluorine atom), and 7.89 to 7.93 ppm (meta-position hydrogen with respect to the terminal group fluorine atom) were observed.

### Comparative Example 1

The same operation was performed as in Example 1 except that the blending amount of 2,6-difluorobenzonitrile was changed to 69.55 g (0.5000 mol). Properties of the resultant polymer and film for evaluation are set forth in Table 1. From the result of the measurement by 1H-NMR, as a terminal structure of the polymer, the presence of the structure represented by the formula (2) was not found.

### Comparative Example 2

A 3 L four-neck flask was charged with Component (A): 2,6-dichlorobenzonitrile (104.24 g (0.612 mol)), Component (B): 9,9-bis(4-hydroxyphenyl)fluorene (210.25 g (0.600 mol)), sodium carbonate (73.13 g (0.69 mol)) and N-methylpyrrolidone (NMP) (1000 mL). Then, to the four-neck flask, a thermometer, a stirrer, a three-way cock with a nitrogen introducing tube, a Dean-Stark tube and a cooling tube were attached.

After the flask was purged with nitrogen, the resultant solution was heated to 195° C. for 50 minutes, and refluxed for 1 hour by adding a small amount of toluene. Toluene and water generated were removed as needed through the Dean-Stark tube. When the generation of water was not recognized, temperature was gradually increased to 200° C., and at this temperature, the reaction was performed for 4 hours.

After the solution was cooled to room temperature (25° C.), a salt generated was removed using a filter paper. The filtrate was poured into methanol for reprecipitation. The solution was subjected to filtration to isolate cake (residue). The resultant cake was vacuum dried at 60° C. overnight, thereby obtaining a white powder (polymer) (amount yielded: 267 g, yield: 97%). Properties of the polymer obtained are set forth in Table 1. From the result of the measurement by 1H-NMR, as a terminal structure of the polymer, the presence of the structure represented by the formula (2) was not found.

Subsequently, the resultant polymer was redissolved in DMAc to obtain a resin composition having a polymer concentration of 20% by mass. The resin composition was applied using a doctor blade on a support composed of a polyethylene terephthalate (PET), and was dried at 80° C. for 30 minutes and then dried at 150° C. for 60 minutes, thereby forming a film. Then, the film was delaminated from the PET substrate. Thereafter, the film was fixed to a metal frame, and dried at 200° C. for 2 hours, thereby obtaining a film for evaluation with a thickness 30 μm. Properties of the film for evaluation are set forth in Table 1.

TABLE 1

| | | | | | | Film YI | Film YI | Solution | |
|---|---|---|---|---|---|---|---|---|---|
| | | | Tensile | Elongation | Total light | before | after | YI after | |
| | Mw | Tanδ | strength | at break | transmittance | heating | heating | heating | Rth |
| | [—] | [° C.] | [MPa] | [%] | [%] | [—] | [—] | [—] | [nm] |
| Example 1 | 82,000 | 293 | 122 | 45 | 88 | 1.69 | 1.76 | 11.6 | 2 |
| Example 2 | 159,000 | 295 | 129 | 37 | 88 | 1.80 | 1.80 | 11.4 | 3 |
| Example 3 | 58,000 | 292 | 119 | 38 | 88 | 1.87 | 2.30 | 13.1 | 2 |
| Example 4 | 132,000 | 301 | 135 | 15 | 88 | 1.75 | 1.76 | 11.8 | 30 |
| Example 5 | 138,000 | 296 | 130 | 21 | 88 | 1.77 | 1.78 | 11.3 | 23 |
| Example 6 | 164,000 | 281 | 126 | 51 | 88 | 1.76 | 1.81 | 11.1 | 48 |
| Example 7 | 96,000 | 265 | 120 | 56 | 88 | 1.79 | 1.92 | 13.8 | 240 |
| Example 8 | 159,000 | 283 | 124 | 46 | 88 | 1.87 | 1.88 | 12.5 | 29 |
| Comp. Ex. 1 | 530,000 | 295 | 128 | 40 | 88 | 2.41 | 2.63 | 16.7 | 3 |
| Comp. Ex. 2 | 53,000 | 291 | 48 | 13 | 87 | 4.27 | 4.98 | — | 3 |

1. A film comprising a polymer that comprises a structural unit represented by the following formula (1), wherein at least part of the terminal structure of the polymer is at least one structure selected from the group consisting of structural units represented by the following formula (2) and structural units represented by the following formula (3), 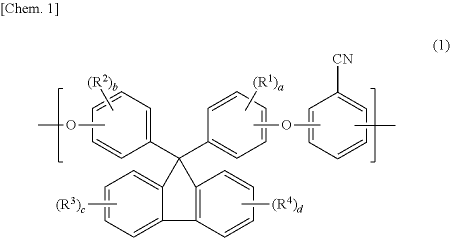
wherein in the formula (1), R¹ to R⁴ are each independently a monovalent organic group having 1 to 12 carbon atoms; and “a” to “d” are each independently an integer of from 0 to 4, 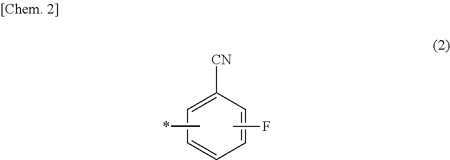
wherein in the formula (2), the symbol “*” indicates a bond, 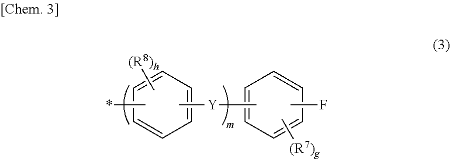
wherein in the formula (3), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; “m” is 0 or 1; and the symbol “*” indicates a bond.

2. The film according to claim 1, wherein 75% or more of the terminal structure of the polymer is at least one structure selected from the group consisting of structural units represented by the following formula (2) and structural units represented by the following formula (3).

3. The film according to claim 1, wherein the polymer further comprises at least one structural unit selected from the group consisting of structural units represented by the following formula (4), structural units represented by the following formula (5) and structural units represented by the following formula (6), 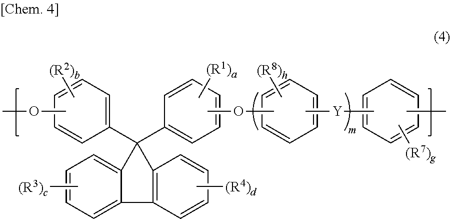
wherein in the formula (4), R¹ to R⁴ and “a” to “d” are each independently defined in the same manner as described for R¹ to R⁴ and “a” to “d” of the formula (1); and R⁷, R⁸, Y, “m”, “g” and “h” are each independently defined in the same manner as described for R⁷, R⁸, Y, “m”, “g” and “h” of the formula (3), 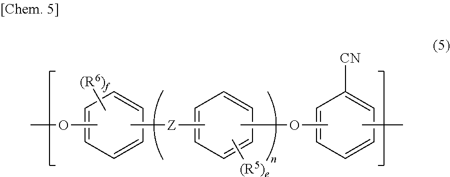
wherein in the formula (5), R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1, 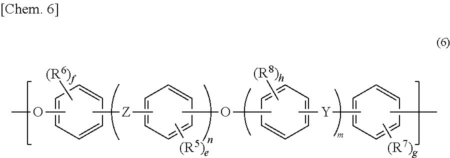
wherein in the formula (6), R⁷, R⁸, Y, “m”, “g” and “h” are each independently defined in the same manner as described for R⁷, R⁸, Y, “m”, “g” and “h” of the formula (3); and R⁵, R⁶, Z, “n”, “e” and “f” are each independently defined in the same manner as described for R⁵, R⁶, Z, “n”, “e” and “f” of the formula (5).

4. A film comprising a polymer obtained by reacting a component (A) with a component (B) at a molar ratio P of the component (A) to the component (B) being 1.0005<P≦1.05, wherein the component (A) comprises at least one compound selected from the group consisting of compounds represented by the following formula (7) and compounds represented by the following formula (8), and the component (B) comprises a compound represented by the following formula (B), 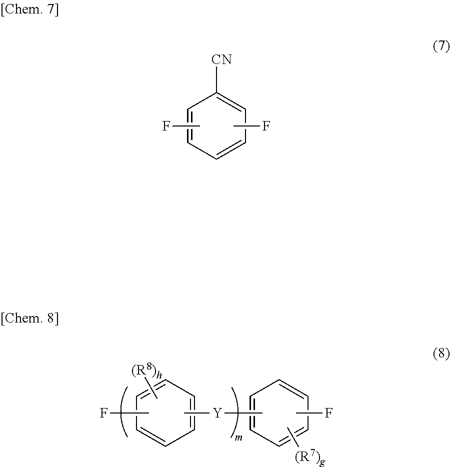
wherein in the formula (8), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; and “m” is 0 or 1, 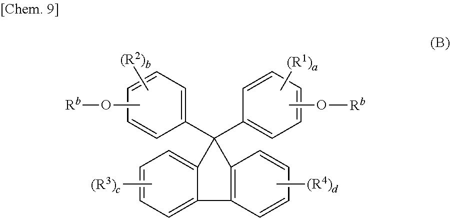
wherein in the formula (B), R^{b} are each independently a hydrogen atom, methyl group, ethyl group, acetyl group, methanesulfonyl group or trifluoromethylsulfonyl group; R¹ to R⁴ are each independently a monovalent organic group having 1 to 12 carbon atoms; and “a” to “d” are each independently an integer of from 0 to 4.

5. The film according to claim 4, wherein the component (B) further comprises a compound represented by the following formula (B′), 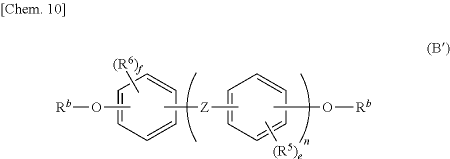
wherein in the formula (B′), R^{b} are each independently defined in the same manner as described for R^{b} of the formula (B); R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

6. The film according to claim 1, which has a glass transition temperature (Tg), as determined by dynamic viscoelasticity measurement (heating rate: 2° C./min, frequency: 10 Hz), of 230 to 350° C.

7. The film according to claim 1, wherein the film, when having a thickness of 30 μm, has a total light transmittance in accordance with JIS K7105 transparency test method of 85% or more.

8. The film according to claim 1, wherein the film, when having a thickness of 30 μm, has a YI value (yellow index) of not more than 3.0.

9. A resin composition comprising an organic solvent and a polymer that comprises a structural unit represented by the following formula (1), wherein at least part of the terminal structure of the polymer is at least one structure selected from the group consisting of structural units represented by the following formula (2) and structural units represented by the following formula (3), 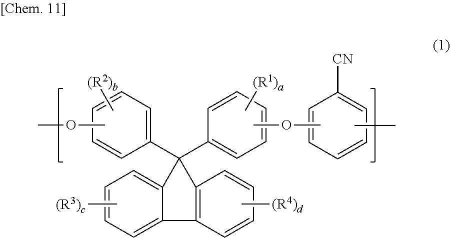
wherein in the formula (1), R¹ to R⁴ are each independently a monovalent organic group having 1 to 12 carbon atoms; and “a” to “d” are each independently an integer of from 0 to 4, 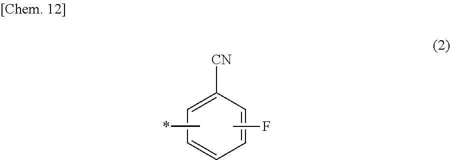
wherein in the formula (2), the symbol “*” indicates a bond, 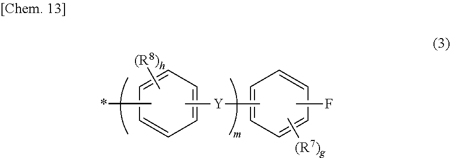
wherein in the formula (3), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; “m” is 0 or 1; and the symbol “*” indicates a bond.

10. The resin composition according to claim 9, wherein the polymer further comprises at least one structural unit selected from the group consisting of structural units represented by the following formula (4), structural units represented by the following formula (5) and structural units represented by the following formula (6), 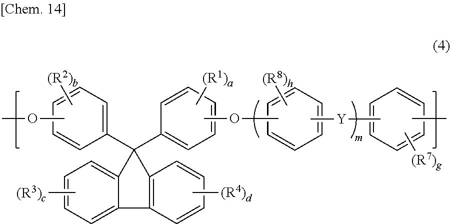
wherein in the formula (4), R¹ to R⁴ and “a” to “d” are each independently defined in the same manner as described for R¹ to R⁴ and “a” to “d” of the formula (1); and R⁷, R⁸, Y, “m”, “g” and “h” are each independently defined in the same manner as described for R⁷, R⁸, Y, “m”, “g” and “h” of the formula (3), 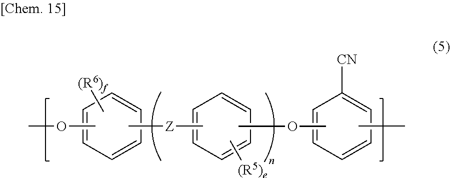
wherein in the formula (5), R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1, 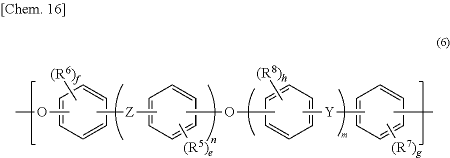
wherein in the formula (6), R⁷, R⁸, Y, “m”, “g” and “h” are each independently defined in the same manner as described for R⁷, R⁸, Y, “m”, “g” and “h” of the formula (3); and R⁵, R⁶, Z, “n”, “e” and “f” are each independently defined in the same manner as described for R⁵, R⁶, Z, “n”, “e” and “f” of the formula (5).

11. A resin composition comprising an organic solvent and a polymer obtained by reacting a component (A) with a component (B) at a molar ratio P of the component (A) to the component (B) being 1.0005<P≦1.05, wherein the component (A) comprises at least one compound selected from the group consisting of compounds represented by the following formula (7) and compounds represented by the following formula (8), and the component (B) comprises a compound represented by the following formula (B), 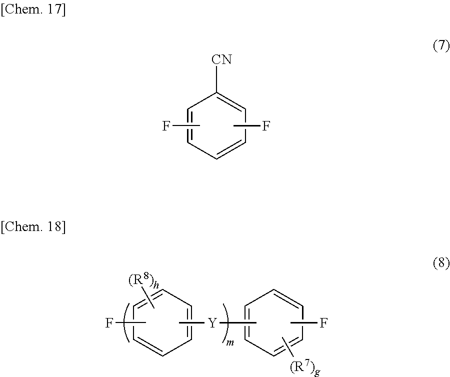
wherein in the formula (8), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; and “m” is 0 or 1, 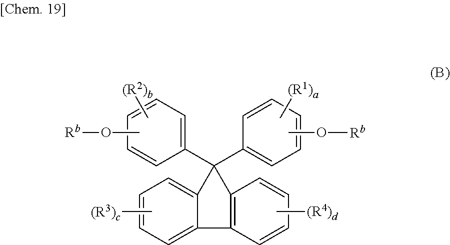
wherein in the formula (B), R^{b} are each independently a hydrogen atom, methyl group, ethyl group, acetyl group, methanesulfonyl group or trifluoromethylsulfonyl group; R¹ to R⁴ are each independently a monovalent organic group having 1 to 12 carbon atoms; and “a” to “d” are each independently an integer of from 0 to 4.

12. The resin composition according to claim 11, wherein the component (B) further comprises a compound represented by the following formula (B′), 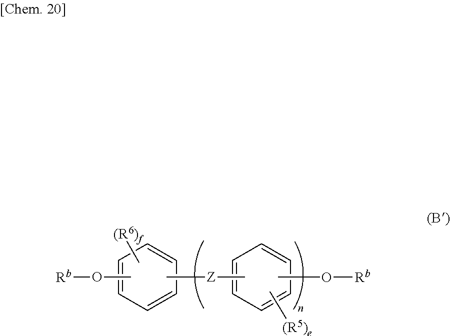
wherein in the formula (B′), R^{b} are each independently defined in the same manner as described for R^{b} of the formula (B); R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

13. A process for producing the film according to claim 1, comprising the steps of applying a resin composition on a substrate to form a coating film, and evaporating the organic solvent from the coating film to remove the organic solvent and thereby provide a film, the resin composition comprising an organic solvent and a polymer that comprises a structural unit represented by the following formula (1), wherein at least part of the terminal structure of the polymer is at least one structure selected from the group consisting of structural units represented by the following formula (2) and structural units represented by the following formula (3), 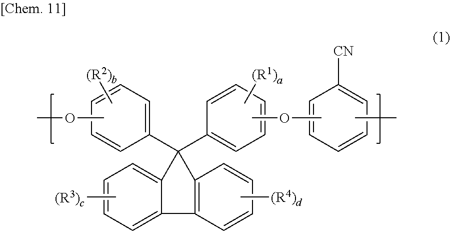
wherein in the formula (1), R¹ to R⁴ are each independently a monovalent organic group having 1 to 12 carbon atoms; and “a” to “d” are each independently an integer of from 0 to 4, 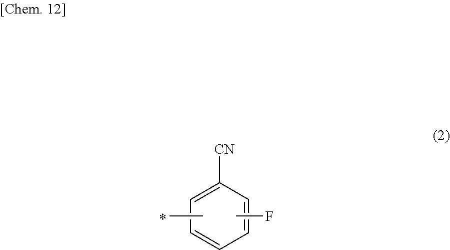
wherein in the formula (2), the symbol “*” indicates a bond, 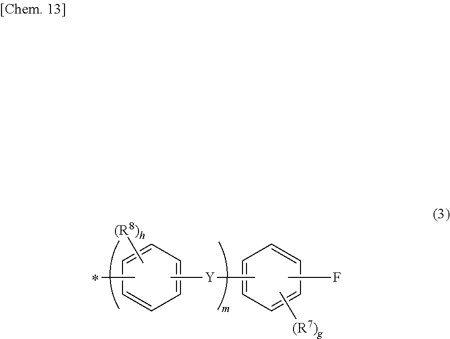
wherein in the formula (3), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; “m” is 0 or 1; and the symbol “*” indicates a bond.

14. A polymer comprising a structural unit represented by the following formula (1), wherein at least part of the terminal structure of the polymer is at least one structure selected from the group consisting of structural units represented by the following formula (2) and structural units represented by the following formula (3), 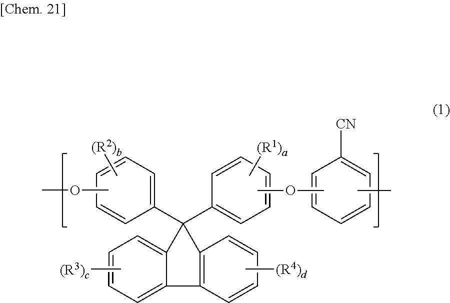
wherein in the formula (1), R¹ to R⁴ are each independently a monovalent organic group having 1 to 12 carbon atoms; and “a” to “d” are each independently an integer of from 0 to 4, 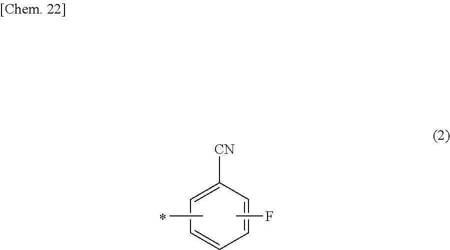
wherein in the formula (2), the symbol “*” indicates a bond, 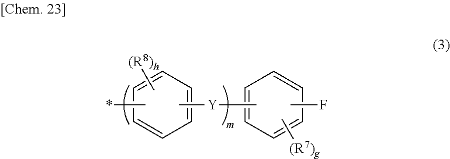
wherein in the formula (3), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; “m” is 0 or 1; and the symbol “*” indicates a bond.

15. The polymer according to claim 14, wherein the polymer further comprises at least one structural unit selected from the group consisting of structural units represented by the following formula (4), structural units represented by the following formula (5) and structural units represented by the following formula (6), 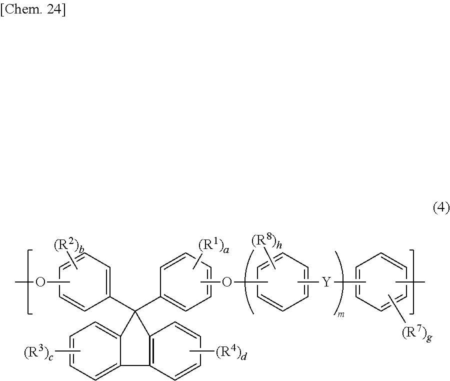
wherein in the formula (4), R¹ to R⁴ and “a” to “d” are each independently defined in the same manner as described for R¹ to R⁴ and “a” to “d” of the formula (1); and R⁷, R⁸, Y, “m”, “g” and “h” are each independently defined in the same manner as described for R⁷, R⁸, Y, “m”, “g” and “h” of the formula (3), 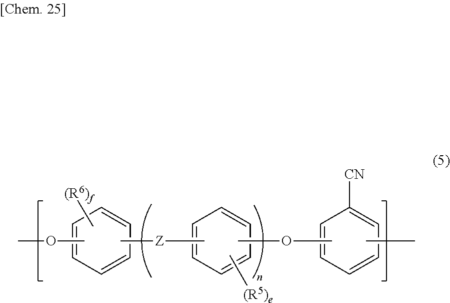
wherein in the formula (5), R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1, 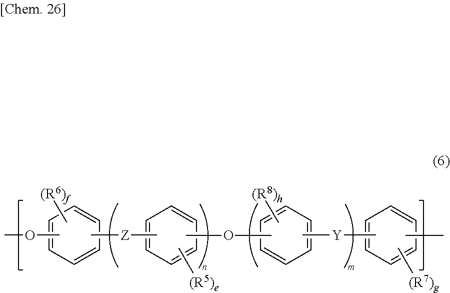
wherein in the formula (6), R⁷, R⁸, Y, “m”, “g” and “h” are each independently defined in the same manner as described for R⁷, R⁸, Y, “m”, “g” and “h” of the formula (3); and R⁵, R⁶, Z, “n”, “e” and “f” are each independently defined in the same manner as described for R⁵, R⁶, Z, “n”, “e” and “f” of the formula (5).

16. A polymer obtained by reacting a component (A) with a component (B) at a molar ratio P of the component (A) to the component (B) being 1.0005<P≦1.05, wherein the component (A) comprises at least one compound selected from the group consisting of compounds represented by the following formula (7) and compounds represented by the following formula (8), and the component (B) comprises a compound represented by the following formula (B), 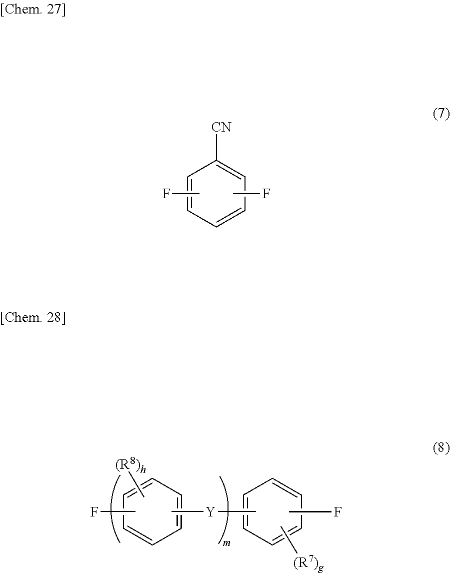
wherein in the formula (8), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; and “m” is 0 or 1, 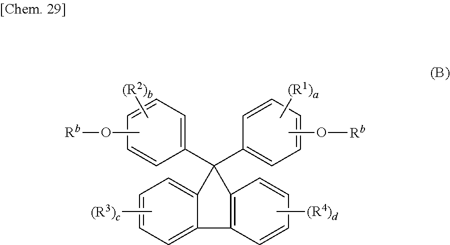
wherein in the formula (B), R^{b} are each independently a hydrogen atom, methyl group, ethyl group, acetyl group, methanesulfonyl group or trifluoromethylsulfonyl group; R¹ to R⁴ are each independently a monovalent organic group having 1 to 12 carbon atoms; and “a” to “d” are each independently an integer of from 0 to 4.

17. The polymer according to claim 16, wherein the component (B) further comprises a compound represented by the following formula (B′), 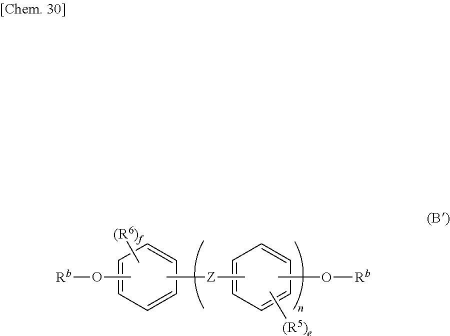
wherein in the formula (B′), R^{b} are each independently defined in the same manner as described for R^{b} of formula (B); R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

18. A process for synthesizing the polymer according to claim 14, comprising a step (I) of reacting a component (A) with a component (B) at a molar ratio P of the component (A) to the component (B) being 1.0005<P≦1.05, wherein the component (A) comprises at least one compound selected from the group consisting of compounds represented by the following formula (7) and compounds represented by the following formula (8), and component (B) comprises a compound represented by the following formula (B), 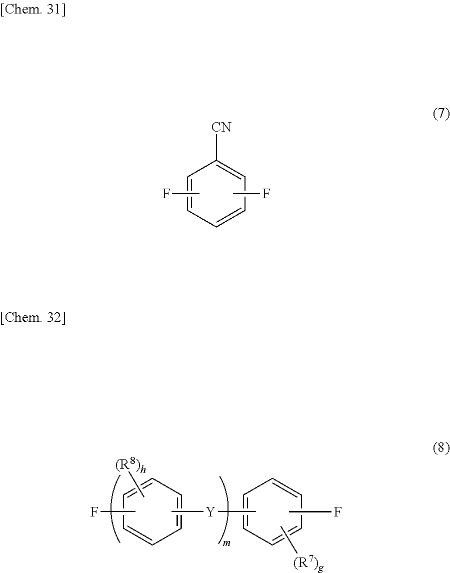
wherein in the formula (8), Y is a single bond, —SO₂— or >C═O; R⁷ and R⁸ are each independently a halogen atom, a monovalent organic group having 1 to 12 carbon atoms or nitro group; “g” and “h” are each independently an integer of from 0 to 4; and “m” is 0 or 1, 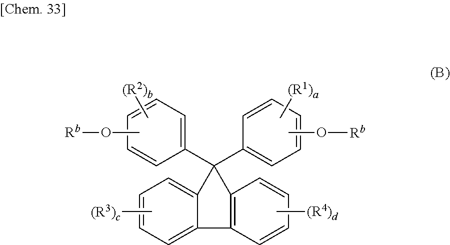
wherein in the formula (B), R^{b} are each independently a hydrogen atom, methyl group, ethyl group, acetyl group, methanesulfonyl group or trifluoromethylsulfonyl group; R¹ to R⁴ are each independently a monovalent organic group having 1 to 12 carbon atoms; and “a” to “d” are each independently an integer of from 0 to 4.

19. The process for synthesizing the polymer according to claim 18, wherein the component (B) further comprises a compound represented by the following formula (B′), 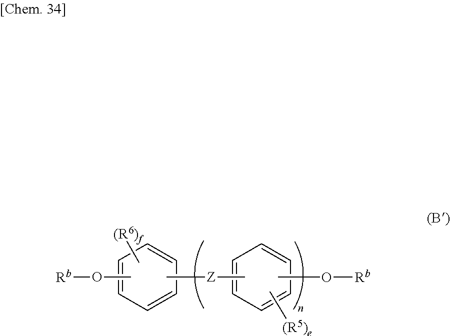
wherein in the formula (B′), R^{b} are each independently defined in the same manner as described for R^{b} of the formula (B); R⁵ and R⁶ are each independently a monovalent organic group having 1 to 12 carbon atoms; Z is a single bond, —O—, —S—, —SO₂—, >C═O, —CONH—, —COO— or a divalent organic group having 1 to 12 carbon atoms; “e” and “f” are each independently an integer of from 0 to 4; and “n” is 0 or 1.

20. The process for synthesizing the polymer according to claim 18, which comprises a step of distilling the compound represented by the formula (7) prior to the step (I).
